(19) United States
(12) Patent Application Publication
(10) Pub. No.: US 2013/0164018 A1
(43) Pub. Date: Jun. 27, 2013

(54) METHOD TO CONTROL THE POWER REQUIREMENT OF A DIGITAL HIGH-CAPACITY PRINTING SYSTEM, AND HIGH-CAPACITY PRINTING SYSTEM TO EXECUTE THIS METHOD

(71) Applicant: Edward Morris, Buchbach (DE)

(72) Inventor: Edward Morris, Buchbach (DE)

(21) Appl. No.: 13/710,628

(22) Filed: Dec. 11, 2012

(30) Foreign Application Priority Data
Dec. 21, 2011 (DE) 102011056735.6

(51) Int. Cl. G03G 15/00

(52) U.S. Cl. CPC G03G 15/80
USPC 399/88

(57) ABSTRACT

In a method or system to control a power requirement of a digital high-capacity printing system that comprises a plurality of individual modules, the modules are connected to a common main current line with which they are supplied with operating current. The individual modules are each provided with a respective processor controller that are connected via a respective data line with a central control device. The individual modules and the central control device are respectively connected to an auxiliary current line that supplies the processor controllers and the central control device with current, independently of the main current line. With the central control device, the individual processor controllers are controlled such that a change of the power requirement is controlled such that at least two of the modules execute the change of the power requirement offset by a predetermined time interval.

### BACKGROUND

The present exemplary embodiment concerns a method to control the power requirement of a digital high-capacity printing system, and a high-capacity printing system to execute this method. In particular, the exemplary embodiment concerns a method to control the power requirement of a digital high-capacity printing system, and a high-capacity printing system to execute this method with a digital print group, which print group is in particular an electrophotographic print group and/or an inkjet print group.

High-capacity printing systems are often of modular design, wherein the individual modules satisfy different tasks. There are thus drive modules that drive a paper web to be conveyed by means of rollers; print modules which have one or more print groups to print to the paper web; modules which turn a paper web; and different pre- and post-processing modules to cut, punch, and fold the printed paper web or paper web to be printed.

These modules normally respectively have a separate mains adapter that is connected with a main current line. Upon activation, during an activation phase these modules require a predetermined electrical power that is typically higher than the electrical power during the normal operation.

The individual modules are normally activated simultaneously, meaning that a very high demand for electrical power exists during a relatively short activation phase. The power supply lines must be dimensioned accordingly so that they can provide the power requirements upon activation.

There are also high-capacity printing systems in which the individual modules are activated individually by hand. Since the number of modules is normally greater than the number of operators to operate the high-capacity printing system, the activation of the individual modules takes place with a chronological offset. A maximum requirement for electrical power is hereby significantly smaller than given simultaneous activation of all modules. However, the activation process takes significantly longer. There can additionally be problems when a predetermined order with which the modules are activated is not observed, since the activation of large modules at the beginning of the activation process can lead to severe overshooting on the main current line, which leads to incorrect triggerings of the fuses. Interfering reactions at the main current line or at the power supply network with connected transformers and feed lines can also arise upon deactivation of the modules, due to return voltages generated via induction. Such reactions—and voltage fluctuations connected with these—can in particular generate problems when the electrical energy stored in the individual modules is abruptly emitted to the power supply network.

### SUMMARY

It is an object to achieve a method to control the power requirement of a digital high-capacity printing system, and a high-capacity printing system to execute this method, wherein the high-capacity printing system comprises multiple modules so that in particular the activation and deactivation of said digital high-capacity printing system can take place reliably, and the over-sizing of the current feed can be kept as minimal as possible.

In a method or system to control a power requirement of a digital high-capacity printing system that comprises a plurality of individual modules, the modules are connected to a common main current line with which they are supplied with operating current. The individual modules are each provided with a respective processor controller that are connected via a respective data line with a central control device. The individual modules and the central control device are respectively connected to an auxiliary current line that supplies the processor controllers and the central control device with current, independently of the main current line. With the central control device, the individual processor controllers are controlled such that a change of the power requirement is controlled such that at least two of the modules execute the change of the power requirement offset by a predetermined time interval.

### BRIEF DESCRIPTION OF THE DRAWINGS

FIG. 1 is a high-capacity printing system according to an exemplary embodiment in rough schematic presentation in a block diagram;

FIG. 2 is a table of a high-capacity printing system with eight modules that are switched with chronological offset;

FIG. 3 shows a time curve of the required power during the activation; and

FIG. 4 shows a time curve of the required electrical power during the activation when all modules are connected to the main current line simultaneously.

### DESCRIPTION OF THE PREFERRED EXEMPLARY EMBODIMENTS

For the purposes of promoting an understanding of the principles of the invention, reference will now be made to preferred exemplary embodiments/best mode illustrated in the drawings and specific language will be used to describe the same. It will nevertheless be understood that no limitation of the scope of the invention is thereby intended, and such alterations and further modifications in the illustrated embodiments and such further applications of the principles of the invention as illustrated as would normally occur to one skilled in the art to which the invention relates are included.

In the method according to the exemplary embodiment to control the power requirement of a digital high-capacity printing system, a high-capacity printing system is used that comprises multiple modules, wherein
the modules are connected to a common main current line with which the individual modules are supplied with the operating current,
the individual modules respectively have a processor controller that are connected via data lines with a central control device, and
the individual modules are respectively connected to an auxiliary current line that supplies the processor controllers and the central control device with current, independent of the main current line.

The method is characterized in that the central control device controls the individual processor controllers of the modules such that the processor controllers of these modules control the change of a power requirement such that at least two of the modules execute the change of the power requirement with an offset by a time interval relative to one another.

The change of the power requirement can be a complete connection of a module to the main current line, or a complete disconnection of the module from the main current line. It can also be a change of the power requirement during the running operation of the module, for example by running up or down of a motor, or by activating or deactivating another electrical load within the module.

The time interval at which at least two of the modules, offset relative to one another, execute the change of the power requirement can in particular be predetermined, and in particular can be stored in a workflow plan. It can also be adjustable.

The term “power requirement” can also comprise a power demand, wherein a differentiation can be made between
the request of a power requirement by a module by means of a power change request sent to the central control device,
the assignment of a maximum power demand by the central control device to the module by means of a power change confirmation, and
the actual power demand, i.e. the actual power consumption of the module in its operation, which can be communicated by the module to the central control device by means of a power usage message.

The processor controllers of the individual modules as well as the central control device can respectively be supplied altogether or in groups with a separate auxiliary current line or with one or more common auxiliary current lines.

The individual modules can respectively have a switching element that switches the connection to the main current line and can be activated by the respective processor controller. The change of the power requirement here takes place via connection and/or disconnection to or from the main current line by means of the switching element. This connection or disconnection of the individual modules can also take place with an offset by an in particular predetermined time interval.

The linking of a module with the main current line is also designated as a switching on or connection of a respective module. The disconnection of a module from the main current line is also designated as a deactivation or switching off of the respective module.

If at least some of the modules are connected to the main current line with a time offset relative to one another, it can be ensured that, upon activation, the increased power requirement during the activation phase of the individual modules is not simultaneously applied to the main current line, such that the total power requirement during the activation phase is significantly reduced relative to the simultaneous activation of all modules.

In that two or more modules are not simultaneously disconnected from the main current line, it is avoided that the reactions arising upon deactivation of the modules are simultaneously present at the main current line, whereby the load for the main current line is correspondingly reduced.

The time duration of the activation phases of the individual modules during which an increased power requirement exists can differ significantly from the time durations during which the reaction of the individual modules occurs at the main current line upon deactivation. Therefore, it can be appropriate to provide different time intervals for switching of the individual modules upon connection or disconnection to or from the main current line.

According to one development of the present exemplary embodiment, the processor controllers send a message to the central control device with which they communicate a change of the power requirement. This message is designated in the following as a power change request. The central control device then respectively sends corresponding power change confirmations to the processor controllers with a time delay, and in particular sequentially per module according to the specification of the arriving power change requests, such that they the respective module can implement the corresponding power change. The respective time delays can be predetermined in a workflow plan or can arise individually, depending on the situation, when it is provided (for example) that the main controller executes the power change confirmations per module in the order of the input of the power change requests, according to the “first come first serve” principle, wherein it sends the confirmation respectively first to a next module when, in the preceding module after the confirmation of its power requirement, it has also been determined what power it actually demands. The development of a power change request in particular comprises the process steps

transmit the power change inquiry from the module to the control device,

in the central control device, check whether there is still sufficient power overcapacity in the power supply,

transmit the power change confirmation to the module, and

set the new power in the module.

If the actual consumption of the module or the power change in the main current line that is caused by its power change is subsequently measured (in particular before a power change inquiry of a next module is developed) and is reported to the central control device, a correction or re-establishment of the still remaining available power overcapacity of the power supply can take place there and be taken into account for the subsequent module inquiry. The actual power capacity of the power supply that is actually required, as well as the power capacity that is still available, can therefore be determined with more precision. The power that is required as a whole can be defined more precisely in the design of the complete system, and therefore an unnecessarily strong overdimensioning of the power supply can be avoided.

The power change requests of the individual modules can arrive quasi-simultaneously at the central control device. A correspondingly delayed changing of the powers or switching in the individual modules is produced via the delayed emission of the power change confirmations to the individual modules. It is advantageous that the central control device controls the time intervals between the individual power change processes, and that the processor controllers do not independently select the power change point in time, because—if a problem should occur—the central control device can then change the workflow of the power change processes and suppress possible additional power change processes.

In an alternative embodiment, it is possible that the power change confirmation to the processor controllers includes the respective points in time at which the respective processor controllers implement the corresponding power changes, for example activate the switching elements to connect or disconnect the module with or from the main current line.

A list with points in time for implementation of the power changes (for example the connection or disconnection of the individual modules with the main current line) is advantageously stored in the central control device. The individual power changes—for example the activation or deactivation of the entirety of the modules or of parts of the high-capacity printing system that comprise multiple respective modules—are controlled by the central control device. This list thus defines a workflow plan of when which module should change its power or should be switched in terms of its power.

According to one preferred exemplary embodiment of the present invention, to switch the modules these are assembled into groups, wherein the modules of the groups are connected with the main current line or disconnected from the main current line simultaneously. For activation, groups of modules are formed that have a relatively low power requirement during the activation phase, such that the simultaneous activation of the modules of the groups does not lead to an excessive loading of the main current line, and the entire activation process is accelerated via the simultaneous activation of the modules of one of the groups. The groups are advantageously assembled such that the electrical power required for activation does not exceed a predetermined value.

According to a further advantageous development of the present exemplary embodiment, modules whose power requirement during the activation phase is above a predetermined value are only connected with the main current line when one or more modules with a lower power requirement during the activation phase have already been activated, such that a defined base load is already present on the main current line. An overshoot or undershoot can occur in a switching process. If a defined base load is already present, it is ensured that no negative power requirement (meaning that energy is fed back into the main current line) is generated given an undershoot. This can lead to significant disruptions.

In one simple exemplary embodiment of the present invention, a defined, preset time interval can respectively be present between the switching processes of the individual modules or the groups of modules.

However, it is also possible that the time intervals are varied between the individual switching processes of the individual modules or the groups of modules. This is advantageous in particular when the time durations during which the individual modules cause an increased current requirement differ, or when the time durations during which the individual modules react at the main current line upon deactivation, should also vary.

In particular, it can be appropriate to measure the power present at the main current line or the current present at the main current line, and to execute the power changes at the individual modules depending on the measurement value.

According to a preferred embodiment, the power change requests include the magnitude of the desired power change, and the power change confirmations can include the magnitude of the confirmed power change. The magnitude of the power change confirmation can also be smaller than the magnitude of the corresponding power change request. Either the module can then not implement the power change, or it must possibly be implemented more slowly than planned so that the confirmed magnitude of the power change satisfies the module. After implementation (or corresponding non-implementation) of the power change, the processor controller of the respective module sends a message to the central control device that it now uses or does not use the confirmed power. This message is designated as a power utilization message in the following.

In the high-capacity printing system according to the exemplary embodiment, the central control device and the processor controller are designed to execute one of the methods according to an exemplary embodiment that are explained above.

The switching elements are relays. The relays can be of conventional mechanical design. They can also be designed as semiconductor relays, wherein they comprise transistors, thyristors or triacs, for example. They can also be made up of a combination of mechanical relays and semiconductor relays.

The high-capacity printing system advantageously has a measurement device to measure the electrical power in the main current line. The measurement device is connected with the central control device such that the activation or deactivation of the individual modules is controlled depending on the current, measured electrical power. This is particularly appropriate if the power requirement or the reaction upon activation or deactivation of the individual modules can vary. For example, different amounts of energy (and therefore a different power requirement) are required upon activation of a module to drive an input-side paper roll depending on the loaded amount of paper. If a large and heavy paper roll is located in this module, significantly more energy is then required to accelerate the paper roll than given a small and light paper roll. Different amounts of energy can accordingly also be stored electrically and/or mechanically in the individual module, which energy is released in electrical form upon deactivation and, for example, is dissipated via a feedback into the power supply network or into a suitable power storage. A power recovery is thus also possible.

The digital high-capacity printing system according to the exemplary embodiment comprises at least one digital print group. For example, the digital print group is an electrophotographic print group or an inkjet print group that is digitally controlled to print a print image.

The exemplary embodiment is explained as an example in the following using the exemplary embodiment shown in the drawings.

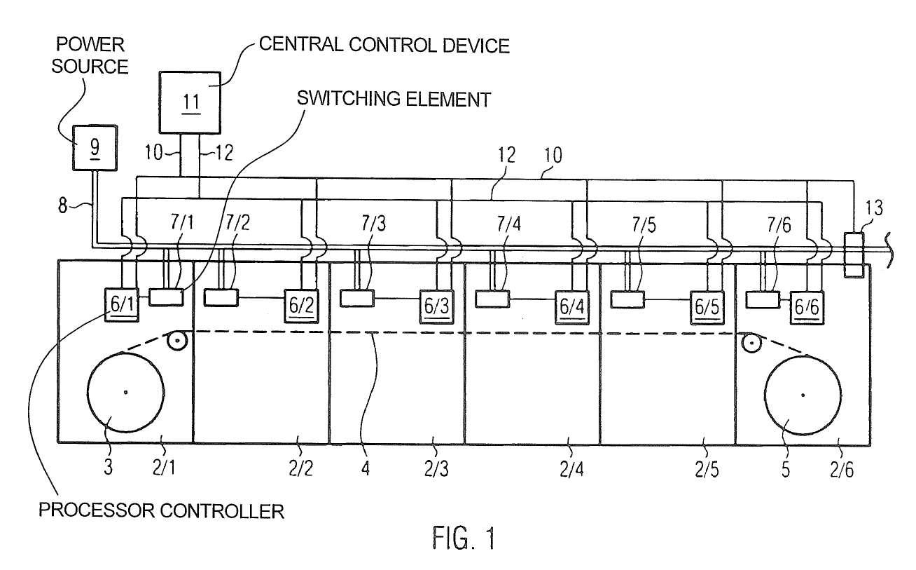

A digital high-capacity printing system 1 shown in FIG. 1 has multiple modules 2. The individual modules 2/1, 2/2, 2/3, 2/4, 2/5 and 2/6 satisfy different tasks. There are thus drive modules that drive a paper web 4 to be conveyed by means of rollers; print modules which have one or more print groups to print to paper webs; modules which turn a paper web; and different pre- and post-processing modules for cutting, punching, or folding of the printed paper web or paper web to be printed. In the present exemplary embodiment, the print modules are provided with an electrophotographic print head. Within the scope of the exemplary embodiment it is also possible that other digital print heads (in particular inkjet print heads) can be provided.

FIG. 1 shows (in only a roughly schematic presentation) an input module 2/1 in which is located a paper roll 3 from which the paper web 4 is drawn in order to be rolled up at an output side paper roll 5 with a module 2/6. For a simple presentation, the individual function elements in the modules 2 are not drawn.

A respective processor controller 6 (namely 6/1, 6/2, 6/3, 6/4, 6/5 or 6/6) and a respective switching element 7 (namely 7/1, 7/2, 7/3, 7/4, 7/5 and 7/6) are shown in FIG. 1 only in the individual modules 2/1 through 2/7. The switching elements 7 are respectively connected with a main current line 8 that is connected to a power source 9. The power source 9 provides electrical energy or power with sufficient capacity to operate the high-capacity printing system 1.

The switching elements 7 are respectively connected with a processor controller 6 such that the processor controller can switch the switching elements 7. The switching elements 7 possess two states in which the function elements of the modules are either connected with the main current line 8 or are disconnected from this. The switching elements 7 are advantageously relays so that the electrical connection between the processor controller 6 and the switching elements 7 is electrically separated from the electrical connection to the main current line 8.

The processor controllers 7/1, 7/2, 7/3, 7/4, 7/5 and 7/6 are respectively connected via a data line 10 with a central control device 11. They are permanently supplied with current by means of a common auxiliary current line 12 which, in the present exemplary embodiment, is also connected with the central control device 11. Provided at the main current line 8 is a measurement device that is connected via the data line 10 with the central control device 11. It measures the current flowing in the main current line 8 and/or the power transferred on the main current line 8. The central control device 11 uses the measurement results to approve power inquiries of the modules 2. The data line 10 can be designed as a central data line in the manner of an in particular digital data bus system to which are connected all processor controllers 6 as well as the central control device 11. It can also be provided that individual process controller or all of the process controllers 6 have individual data lines to the central control device 11.

The high-capacity printing system according to FIG. 1 has six modules 6/1, 6/2, 6/3, 6/4, 6/5 and 6/6. Within the scope of the exemplary embodiments it is naturally possible that the high-capacity printing system 1 has a different number of modules.

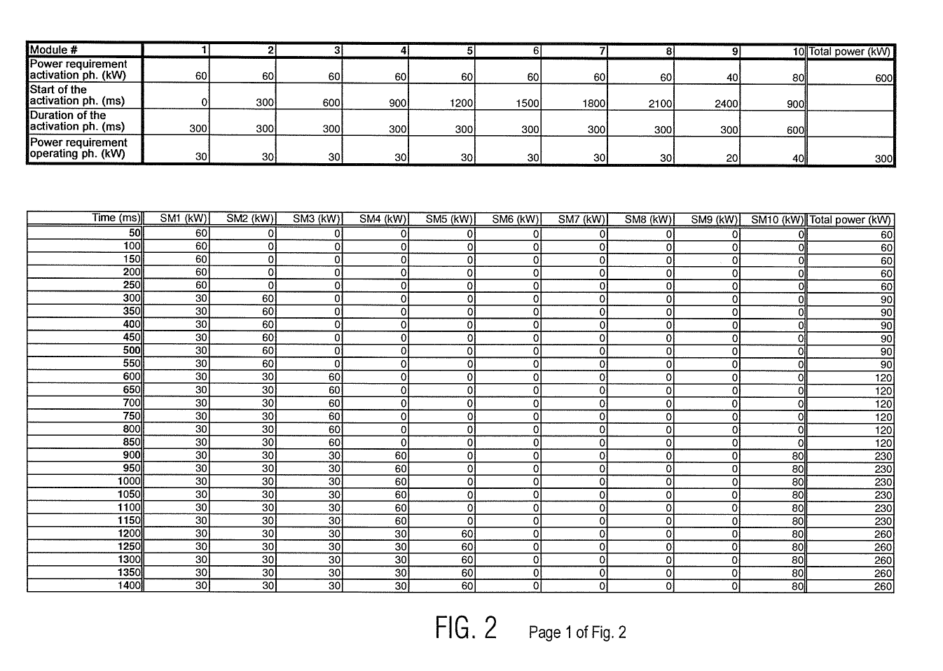

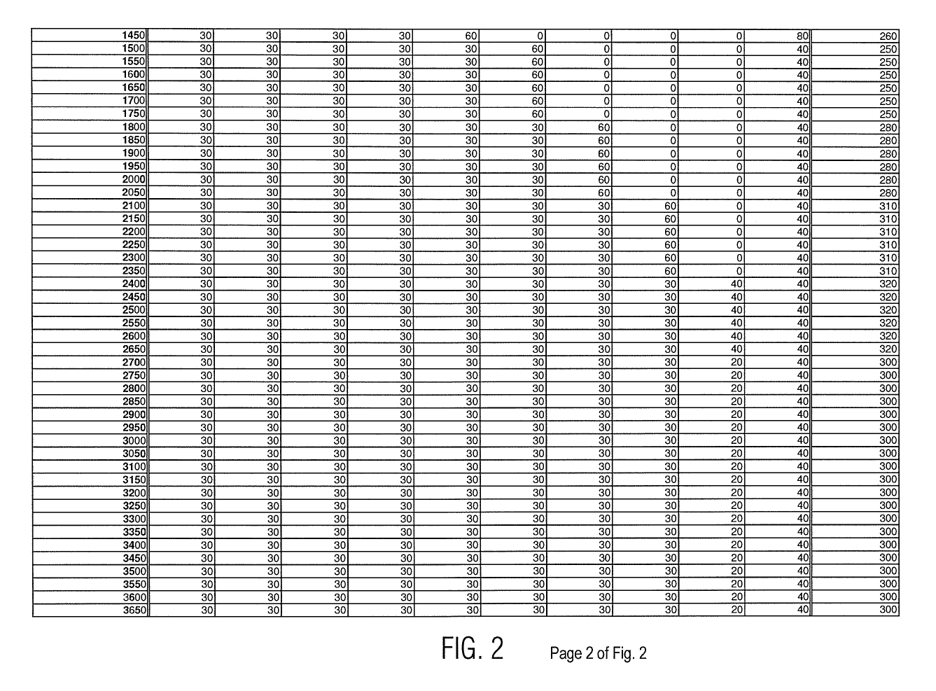

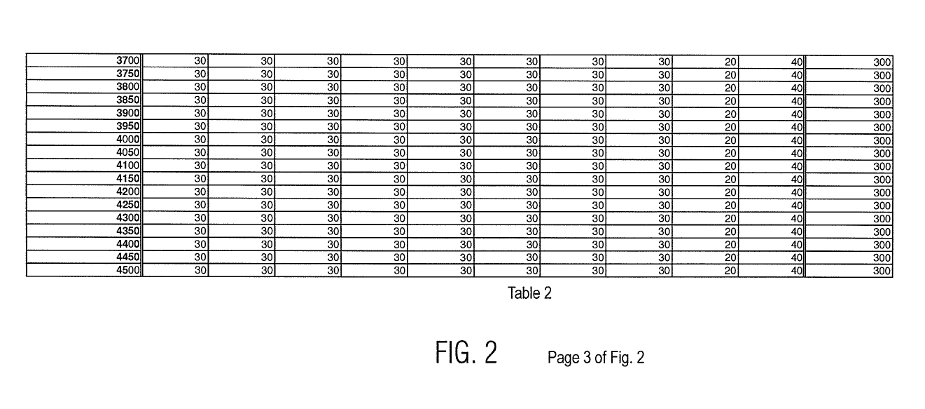

Examples of tables and diagrams for a high-capacity printing system with 10 modules in total are shown in FIGS. 2 through 4. In Table 1 (FIG. 2), for each of the modules SM1 through SM10 the power requirement during the activation phase is specified in kW, the start point in time of the activation phase is specified in ms, the duration of the activation phase is specified in ms, and the power requirement in the operation phase is specified in kW.

The activation phase is the period of time in which the respective modules have an increased power requirement relative to the normal operating phase in which can be printed. The level of this power requirement can differ between individual modules. This duration of the activation phase of the individual modules can also differ. After the activation phase, the modules respectively transition into the normal operation, which is also designated in the following as an activation phase.

Table 2 (FIG. 2) shows the power requirement of the individual modules SM1 through SM10 in time intervals of 50 ms (respectively) during an optimized activation process in kW. In this example, individual modules are activated every 300 ms. The module 10 is activated simultaneously with the module 4 at 900 ms. Individual modules SM1, SM2, SM3 are initially activated individually in succession in order to generate a certain base load. If a base load (for instance 120 kW here) is present, modules with an increased power requirement or multiple modules can then also be activated at the same time. However, it is hereby to be heeded that the current power requirement does not exceed the total power demand during the operating phase of all modules. In the present exemplary embodiment, the total power demand in the operating phase of all modules is 300 kW. A module that has the least increase of the power demand during the activation phase (here module SM9 with 20 kW difference between the activation phase and the operating phase) is advantageously connected last. The superelevation of the power requirement during the activation process can hereby be kept very low relative to the power requirement during the operating phase of all modules. This superelevation is determined by the increased power requirement of the last module relative to the operating phase. In the present case, this increase amounts to 20 kW relative to the total nominal power requirement of 300 kW.

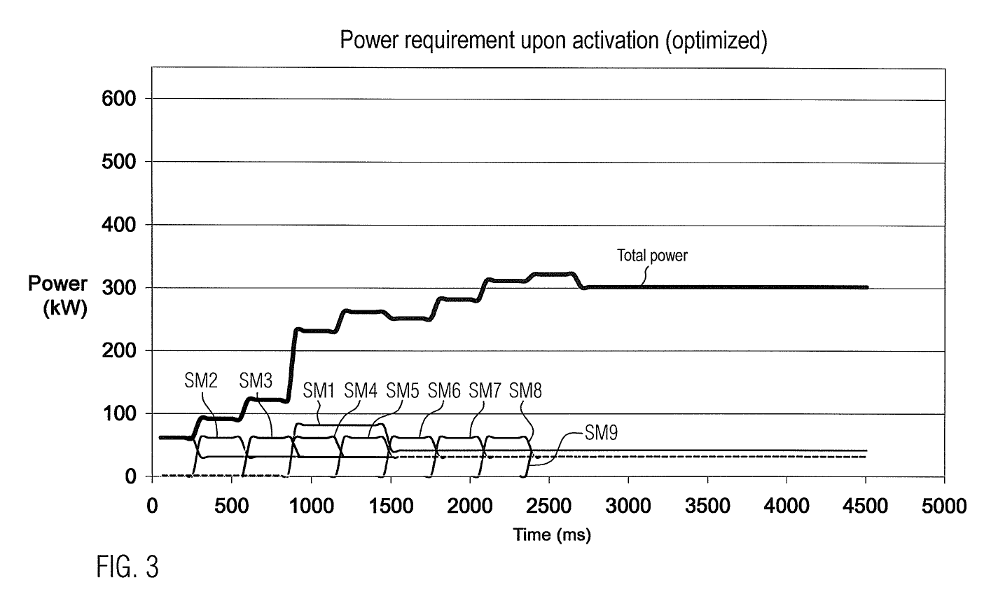

The time curve of the required power (which belongs to Table 2) during the optimized activation process is graphically depicted in FIG. 3.

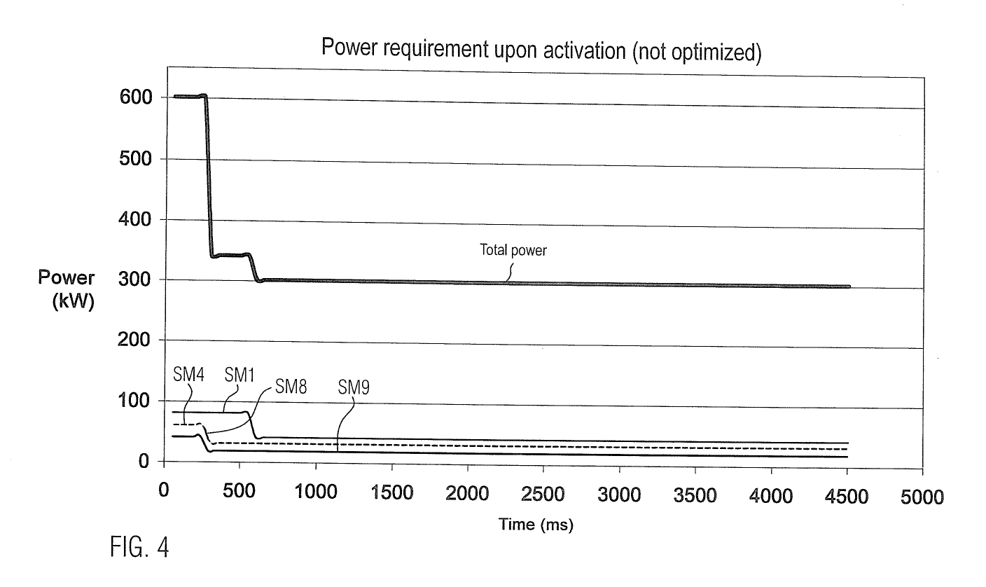

In contrast to this, if all modules were activated simultaneously (i.e. without optimization), the curve shown in FIG. 4 would result. There would then initially be a power requirement of 600 kW. The main current line would need to be designed accordingly in order to be able to supply a correspondingly high power. If the high-capacity printing system according to the exemplary embodiment is ramped according to the activation process presented in Tables 1 and 2 from FIG. 2, a maximum power requirement of approximately 320 kW then results. The main current line can be designed with a correspondingly low capacity. This saves significant costs.

The points in time for activation of the individual modules are advantageously controlled by the central control device 11 so that the activation process can be interrupted given a problem, and no additional modules are connected.

In the deactivation of the high-capacity printing system, the individual modules SM1 . . . SM10 are accordingly deactivated with a time offset, wherein here the time intervals between the deactivation processes can be significantly differentiated relative to the time intervals between the activation processes, and in particular are shorter since the reactions at the power grid are correspondingly shorter.

If one or more modules 2 have a variable power requirement during the activation phase that depends on additional parameters, it can then be appropriate to measure the power or the current in the main current line and individually activate or deactivate the modules depending on the measurement value.

In some countries, the maximum amperage for power supplies is limited. Higher amperages can only be delivered by special power supplies that are significantly more expensive. For example, in the USA there is often a value of 100 A as an upper limit for the maximum deliverable current. Since the voltage is fixed, the maximum power is also limited by the current. Large high-capacity printing apparatuses can be connected to a typical, standardized power supply with the present exemplary embodiment since the maximum current requirement is reduced via the exemplary embodiment.

The exemplary embodiment is explained above using an example for activation and deactivation of the individual modules. However, the exemplary embodiment is not limited to the activation and deactivation of the individual modules; rather, it can also detect any additional power change during the running operation.

In principle, the control of the change of the power consumption of a module takes place via the exchange of the following messages between the processor controllers 6 of the modules and the central control device 11:

power change request [Power Needed]

power change confirmation [Power Granted]

power utilization message [Power Used]

The power change request is sent by the respective processor controller of the modules to the central control device when the respective module would like to change its power consumption. This message includes an identifier of the respective module so that the central control device can associate it with the respective module. Furthermore, the power change request includes information about the desired power change. This information can be that the module should be connected with the main current line or be disconnected from this. In one development, the information can also include a magnitude for the power change that is indicated in kW, for example. Depending on the operating state, specific modules can also send power change requests with different magnitudes, for example if a specific function element (for example a motor) should be ramped up or down.

The central control device 11 at which a power change request arrives checks whether and when the requested power is provided. A corresponding power change confirmation is sent at the point in time at which the power is provided to the module that has sent the power change request.

If only a lower power is available, the central control device 11 then emits a modified power change confirmation message with which it is communicated to the module that the desired power requirement is not available. What lower power is available can hereby be simultaneously communicated to the module. The module can hereupon send a modified power change request with a reduced power requirement. However, the method can also be designed so that the module uses the corresponding lower power without an additional power change request.

The module, which has correspondingly modified its reported power requirement, sends a power utilization message to the central control device in which the magnitude of the modified power is communicated.

The central control device can dynamically control or assign the power requirement to a plurality of modules, which is why the central control device can also be designated as a “Dynamic Power Arbitrator (DPA)”.

If there is significant need for high power for a temporary time duration at a module—for example upon activation of a module—then the central control device can temporarily reduce the power allocated to the other modules and provide it for the activation of this module. The central control device can therefore also send unrequested power change confirmations to modules in order to correspondingly adjust their power requirement.

The central control device monitors the power requirement of the individual modules such that a maximum permissible total power on the main current line is not exceeded. An additional criterion for the review of a power change request can be a surge to be expected due to the power change or the power spike that is hereby caused.

Each module is responsible for the corresponding power being assigned to it by the central control device. The power change can be both a power increase and a power decrease.

The exemplary embodiment has been described using a printing system with multiple modules. It can also be applied to multiple printing systems that have a common power supply. Such a power supply system can therefore be designed so as to be scalable, wherein it can be designed hierarchically, with a superordinate central control device and multiple subordinate control devices (first subordinate layer). The subordinate control devices can for their part in turn have multiple control devices subordinate to them (second subordinate layer) and act on them, relatively, as a central control device etc., wherein in general n subordinate layers are possible where n is a natural number. The control commands described above can then respectively be exchanged per layer between subordinate and superordinate controllers, and control functions can be executed

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

We claim as our invention:

1. A method to control a power requirement of a digital high-capacity printing system that comprises a plurality of individual modules, comprising the steps of:
providing each of the individual modules with a respective processor controller that are connected via a respective data line with a central control device;
also connecting the modules to a common main current line with which the individual modules are supplied with operating current;
also connecting the respective individual modules and the central control device to an auxiliary current line that supplies the processor controllers and the central control device with current independently of the main current line; and
with the central control device, controlling the individual processor controllers of the modules such that the processor controllers of said modules control a change of the power requirement such that at least two of the modules execute the change of the power requirement offset by a predetermined time interval relative to one another.

2. The method according to claim 1 wherein the individual modules respectively have a switching element that switches the connection to the common main current line and can be activated by the respective processor controller such that the corresponding module is connected to the main current line and/or is disconnected from the main current line.

3. The method according to claim 1 wherein the processor controllers send a message to the central control device with which they communicate a power change requirement designated as an incoming power change request, and the central control device sends corresponding power change confirmations to the processor controllers with a time delay according to a specification of the incoming power change requests such that said processor controllers control the respective power change.

4. The method according to claim 3 wherein the power change request includes information that the corresponding module is to be connected with or disconnected from the main current line, or a magnitude of the power change.

5. The method according to claim 1 wherein a list with points in time for the connection or disconnection of the individual modules with the main current line is stored in a central control device, and activation or deactivation of an entirety of the high-capacity printing system, or of parts of the high-capacity printing system comprising the plurality of respective modules, is controlled by the central control device.

6. The method according to claim 1 wherein the individual modules are assembled into groups, and the modules of the groups are simultaneously connected with the main current line or disconnected from the main current line.

7. The method according to claim 1 wherein a sum of respective powers of all modules does not exceed a predetermined value.

8. The method according to claim 1 wherein the plurality of modules have a different requirement for electrical power upon activation, and the modules whose power requirement is over a predetermined value are only connected with the main current line if one or more of the modules with a lower power requirement have already been activated in an activation such that a defined base load is present on the main current line.

9. The method according to claim 1 wherein the modules are connected with the main current line or are disconnected from the main current line individually or in groups, respectively, with a preset defined time interval.

10. The method according to claim 1 wherein a module that, of all modules, has a smallest difference between a power requirement during an activation phase and a power requirement during an operating phase is activated as a last module.

11. The method according to claim 1 wherein the processor controllers communicate power changes to the central control device by means of power change requests both upon activation and deactivation, and during operation, and said central control device confirms the power change requests by means of power change confirmations, wherein a point in time of the respective power change is controlled by means of the power change confirmations.

12. A high-capacity printing system that comprises a plurality of individual modules, comprising:
the individual modules being connected to a common main current line with which the individual modules are supplied with an operating current;
the individual modules each having a respective processor controller that are connected via a respective data line with a central control device; and
the individual modules and the central control device being respectively connected to an auxiliary current line that supplies the processor controllers and the central control device with current independently of the main current line, wherein the central control device and the processor controllers are designed to control a change of the power requirement by the central control device controlling the individual processor controllers, and such that at least two of the modules execute the change of the power requirement offset by a predetermined time interval relative to one another.

13. The high-capacity printing system according to claim 12 wherein the individual modules have a switching element that switches the connection to the main current line and can be activated by the respective processor controller.

14. The high-capacity printing system according to claim 12 wherein a measurement apparatus for measurement of electrical power and/or electrical current is arranged in the main current line, and the measurement apparatus is connected with the central control device such that the connection or a disconnection of the individual modules is controlled depending on a current value of the measurement.

15. The high-capacity printing system according to claim 12 wherein the system comprises at least one module with a digital print group.

16. A method to control a power requirement of a digital high-capacity printing system that comprises a plurality of individual modules, comprising the steps of:
providing each of the individual modules with a respective processor controller that are connected via a respective data line with a central control device;
also connecting the modules to a common main current line with which the individual modules are supplied with operating current;
also connecting the respective individual modules and the central control device to at least one respective auxiliary current source that supplies the processor controllers and the central control device with current independently of the main current line; and
with the central control device, controlling the individual processor controllers of the modules such that the processor controllers of said modules control a change of the power requirement such that at least two of the modules execute the change of the power requirement offset by a predetermined time interval relative to one another.

17. A high-capacity printing system that comprises a plurality of individual modules, comprising:
the individual modules being connected to a common main current line with which the individual modules are supplied with an operating current;
the individual modules each having a respective processor controller that are connected via a respective data line with a central control device; and
the individual modules and the central control device being respectively connected to at least one respective auxiliary current source that supplies the processor controllers and the central control device with current independently of the main current line, wherein the central control device and the processor controllers are designed to control a change of the power requirement by the central control device controlling the individual processor controllers, and such that at least two of the modules execute the change of the power requirement offset by a predetermined time interval relative to one another.
